(19) United States
(12) Patent Application Publication
(10) Pub. No.: US 2026/0112059 A1
(43) Pub. Date: Apr. 23, 2026

(54) OBJECT DETECTION APPARATUSUSING PLURAL SENSORS, METHOD, AND STORAGE MEDIUM

(71) Applicant: CANON KABUSHIKI KAISHA, Tokyo (JP)

(72) Inventor: HIROTAKA OMORI, Kanagawa (JP)

(21) Appl. No.: 19/354,657

(22) Filed: Oct. 9, 2025

(30) Foreign Application Priority Data
Oct. 22, 2024 (JP) 2024-185764

(51) Int. Cl. G06T 7/77; G06T 5/73

(52) U.S. Cl. CPC G06T 7/77; G06T 5/73; G06T 2207/10024; G06T 2207/10028; G06T 2207/30252

(57) ABSTRACT

An object detection apparatus includes an imaging unit configured to capture an image, and at least one processor that, upon execution of a stored program, is configured to function as a detection unit configured to detect an object exceeding a threshold as a detection target in the captured image, a first change unit configured to change the threshold, a processing unit configured to perform contrast correction on the captured image, a selection unit configured to select a first setting or a second setting, wherein the processing unit performs correction to cause the contrast of the captured image to be lower when the second setting is selected than when the first setting is selected, and a second change unit configured to change the threshold for detecting the detection target in the captured image when the first setting is selected to a value higher than that when the second setting is selected.

### BACKGROUND

### Field of the Technology

The present disclosure relates to an object detection apparatus and an object detection method for detecting an object, and an imaging system thereof.

### Description of the Related Art

An existing object detection apparatus is required to be available under various environments. In a case where the object detection apparatus is used, the environment is not always suitable for capturing images, and an imaging technique corresponding to an environment of the time is required. In a case where the object detection apparatus is used in a vessel or the like, an object may be veiled in fog or mist. When object detection is performed using a visible light image under such an environment, detection accuracy of the object is lowered because of low contrast and insufficient visibility. Because of the above issue, a technique for detecting the object by using information other than the visible light image in addition to the visible light image has been disclosed. Japanese Patent Laid-Open No. 2007-255979 describes a technique for detecting an object by using a visible light image and information acquired from radar and infrared rays other than the visible light image.

It has been proposed to perform mist correction on the visible light image in order to accurately detect a detection target even under a situation where the detection target is veiled in fog or mist. However, execution of the mist correction may cause overlooking or erroneous detection of the detection target.

### SUMMARY

The present disclosure is directed to accurately detecting a detection target by a camera system including a mist correction function.

According to an aspect of the present disclosure, an object detection apparatus includes an imaging unit configured to capture a visible light image, at least one memory storing a program, and at least one processor that, upon execution of the stored program, is configured to function as a detection unit configured to detect an object exceeding a threshold as a detection target in the image captured by the imaging unit, a first change unit configured to change the threshold, a processing unit configured to perform correction processing related to contrast on the image captured by the imaging unit, a selection unit configured to select one setting from a plurality of settings including a first setting and a second setting, wherein the processing unit performs correction processing to cause the contrast of the image captured by the imaging unit to be lower when the second setting is selected than when the first setting is selected, and a second change unit configured to change the threshold for detecting the detection target in the image captured by the imaging unit in a state where the first setting is selected, to a value higher than the threshold for detecting the detection target in the image captured by the imaging unit in a state where the second setting is selected.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of an imaging system according to a first embodiment of the present disclosure.

FIG. 2 is a flowchart illustrating image processing according to the first embodiment.

FIGS. 3A and 3B are diagrams illustrating information respectively acquired by a visible light camera and a radar according to the first embodiment.

FIGS. 4A to 4H are diagrams illustrating gradation correction processing according to the first embodiment.

FIGS. 5A and 5B are diagrams illustrating a method of setting a detection range based on object information according to the first embodiment.

FIGS. 6A and 6B are diagrams illustrating a method of setting a detection size based on the object information according to the first embodiment.

FIGS. 7A and 7B are diagrams illustrating a method of setting an object threshold based on mist correction intensity according to the first embodiment.

FIGS. 8A and 8B are diagrams illustrating a method of setting an object threshold based on object information and mist correction intensity according to a second embodiment.

### DESCRIPTION OF THE EMBODIMENTS

Some embodiments are described in detail below with reference to the accompanying drawings.

One or more of the functional blocks illustrated in the drawings described below may be realized by hardware such as an application specific integrated circuit (ASIC) or a programmable logic array (PLA), or may be realized by a programmable processor such as a central processing unit (CPU) or a microprocessor unit (MPU) executing software.

Further, one or more of the functional blocks may be realized by a combination of software and hardware. Accordingly, even in a case where different functional blocks are described as operation subjects in the following description, the different functional blocks may be realized by the same hardware.

### <First Embodiment>

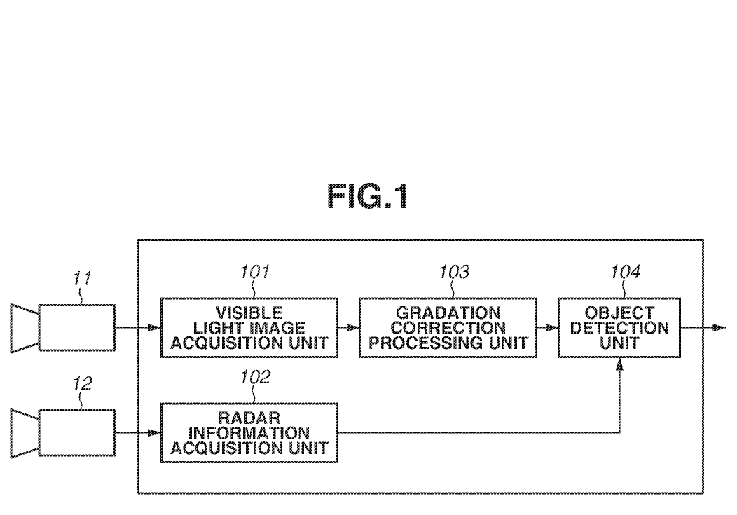

FIG. 1 is a block diagram illustrating a configuration of an imaging system according to a first embodiment of the present disclosure.

A visible light camera 11 captures visible light images. The visible light camera 11 includes an imaging optical system including one or more lenses, and a visible light imaging element (visible light sensor) that captures an optical image formed by the imaging optical system to convert the optical image into an electric signal. The visible light sensor detects, for example, visible light within a wavelength range from about 380 nm to about 750 nm. The visible light sensor may have sensitivity in at least a part of a wavelength range of near-infrared rays.

A radar 12 measures a size, a distance, and azimuth information of an object. The radar 12 emits microwaves having a short wavelength and measures a required time of reflected waves from the object, thereby acquiring, for example, the size, the distance, and the azimuth information of the object. Further, the radar 12 can overlay and associate vessel information and chart data with the measured object based on automatic identification system (AIS) information and global positioning system (GPS) information.

A visible light image acquisition unit 101 acquires a visible light image captured by the visible light camera 11.

A radar information acquisition unit 102 acquires the object information measured by the radar 12. The object information according to the present embodiment is information including the size, the distance, the azimuth information, and the like of the object as described above, but is not limited to these pieces of information, and may include temperature information of the object including a vessel, a person, an animal, and the like, weather information, position information, or speed information.

A gradation correction processing unit 103 performs correction processing on an image lowered in contrast based on the image acquired from the visible light camera 11.

An object detection unit 104 detects an object from the image subjected to the gradation correction processing based on at least one of the object information acquired from the radar information acquisition unit 102 and image processing parameters acquired from the gradation correction processing unit 103. As an object detection method, various methods, for example, a pattern matching method, a method using luminance gradient in a local area, and a method based on machine learning such as deep learning can be adopted.

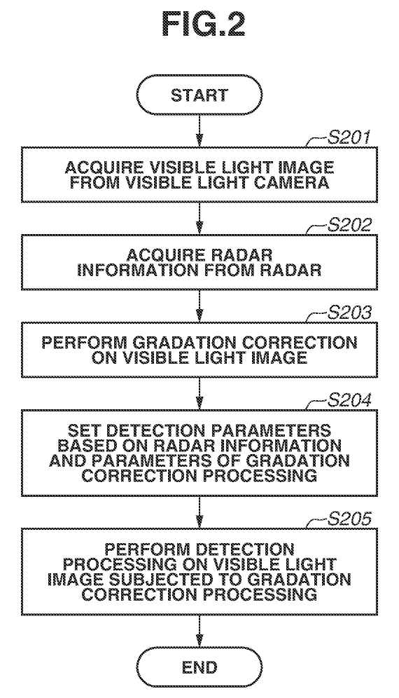

In the following, operation of an object detection apparatus according to the present embodiment is described with reference to a flowchart illustrated in FIG. 2.

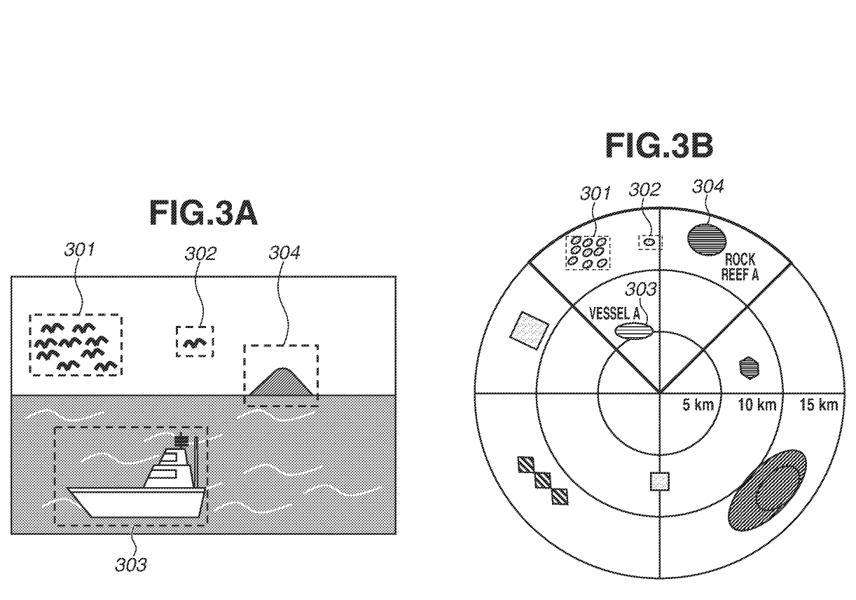

First, in step S201, the visible light image acquisition unit 101 acquires the visible light image captured by the visible light camera 11. FIG. 3A illustrates an example of a video image acquired by the visible light camera 11. In a sunny condition, objects such as flocks of seabirds 301 and 302, a vessel 303, and a rock reef 304 present over a far side to a near side can be detected as illustrated in FIG. 3A. However, under a situation where fog/mist rises as illustrated in a drawing described below, contrast of the entire video image is lowered, and it is difficult to detect the above-described objects only from the information on the visible light image.

In step S202, the radar information acquisition unit 102 acquires the object information measured by the radar 12. FIG. 3B illustrates the size, the azimuth, and the distance of each object acquired from the object information, hull information, and chart data. A thick frame portion illustrated in FIG. 3B indicates an angle of view corresponding to the visible light image illustrated in FIG. 3A, and the size, the azimuth, and the distance information on each of the objects such as the flocks of seabirds 301 and 302, the vessel 303, and the rock reef 304 can be acquired.

In step S203, the gradation correction processing unit 103 performs gradation correction processing on the visible light image. Details of the gradation correction processing are described below.

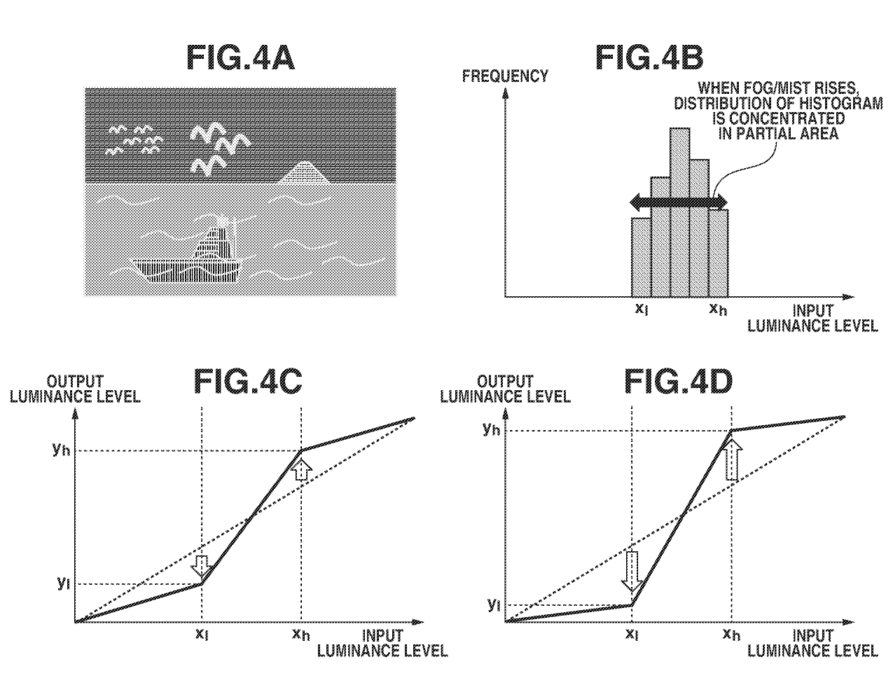

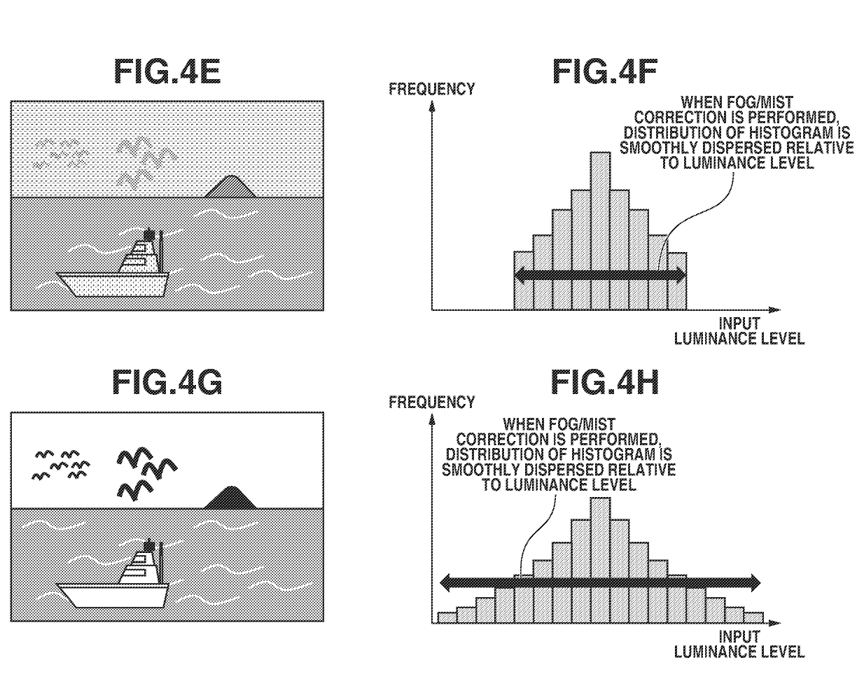

FIGS. 4A and 4B illustrate examples of the visible light image and a histogram in a state where fog/mist rises. As illustrated in FIGS. 4A and 4B, in the state where fog/mist rises, distribution of the histogram is concentrated in a partial area, contrast of the entire screen is low, and detection of an object is difficult. As illustrated in the example of the histogram in FIG. 4B, the distribution is concentrated in an input luminance level of x1 to xh. The input luminance level in which the distribution of the histogram is concentrated may be calculated as a luminance value at which an accumulated value of the histogram becomes a threshold or more. For example, the input luminance level xl is a value of the input luminance level when a frequency is sequentially added from a lower side to a higher side of the input luminance level and the accumulated value becomes the threshold or more. The input luminance level xh is a value of the input luminance level when a frequency is sequentially added from the higher side to the lower side of the input luminance level and the accumulated value becomes the predetermined threshold or more.

FIGS. 4C and 4D illustrate examples of an input/output characteristic curve used for gradation correction (hereinafter, referred to as a gradation correction curve). As illustrated in FIGS. 4C and 4D, the gradation correction curve is set such that output luminance is smoothly changed from yl to yh along the input luminance in a section where the distribution of the histogram is concentrated due to influence of fog/mist (section from xl or more and xh or less). In this example, yl and yh are parameters for controlling a gradation correction effect. When the value yl is smaller and the value yh is larger, the gradation correction effect is enhanced, and an output result with high contrast is obtained. As compared with FIG. 4C, the gradation correction curve illustrated in FIG. 4D has the value yl set small and the value yh set large and indicates that the gradation correction curve has a high correction effect. The correction effect by the gradation correction curve may be changed based on an instruction from a user, dispersion of the histogram, and the like. In the present embodiment, by using correction parameters selectable by the user, such as a "mist correction function" and "mist correction intensity," enablement/disablement of the mist correction function and weak/strong mist correction intensity each may be switched. A method in which the mist correction intensity or mist correction function is manually switched may be adopted, or a method in which the mist correction intensity or mist correction function is automatically switched may be adopted. As an example of the method in which the mist correction intensity or the mist correction function is automatically switched, there is a method in which the histogram is referred to, and in a case where the histogram is distributed in a predetermined section of the input luminance level, the mist correction intensity is switched from weak to strong, or the mist correction function is switched from disabled to enabled.

Subsequently, by applying the calculated gradation correction curve to the visible light image, the gradation correction processing is performed. FIGS. 4E and 4F respectively illustrate a video image and a histogram when "mist correction function" is set to “enabled” and "mist correction intensity" is set to “weak” (second setting). FIGS. 4G and 4H respectively illustrate a video image and a histogram when "mist correction function" is set to “enabled” and "mist correction intensity" is set to “strong” (first setting). In the case where the "mist correction intensity" is set to "weak," the gradation correction curve having the gentle gradient illustrated in FIG. 4C is applied, whereas in the case where the "mist correction intensity" is set to "strong," the gradation correction curve having the steep gradient illustrated in FIG. 4D is applied. In both video images, the distribution of the histogram becomes smoother as compared to the distribution of the histogram before the mist correction is performed, and the video images are corrected to video images with bright/dark contrast. As an adverse effect by application of the gradation correction curve, when the gradation correction curve is an acute S-shaped curve as in the case where the "mist correction intensity" is set to "strong," black fullness or halation may occur on an object having deviation to a low luminance side or a high luminance side. On the other hand, the contrast of the object within a range of a specific input luminance (xl or more and xh or less) is highly corrected. When the gradation correction curve is a gentle correction curve as in the case where the "mist correction intensity" is set to "weak," a video image in which contrast is limitedly given to the object, but black fullness and halation are suppressed, is acquired. Accordingly, in the gradation correction processing (mist correction function) described in the present embodiment, a trade-off by the parameter (mist correction intensity) is present, and the parameter is dynamically changed based on a target and an area to be monitored by the user.

In step S204, detection parameters of the object detection unit 104 are set based on at least one piece of the object information acquired in step S202 and the gradation correction intensity performed in step S203. Details of a method of setting the detection parameters are described below.

The object detection method according to the present embodiment detects a detection target based on parameters necessary for detection. The parameters include a detection range that is a range where the object detection processing is performed, a detected size of the object, and a threshold for performing comparison with an evaluation value indicating a likelihood of the object. The object to be detected in the present embodiment is a seabird.

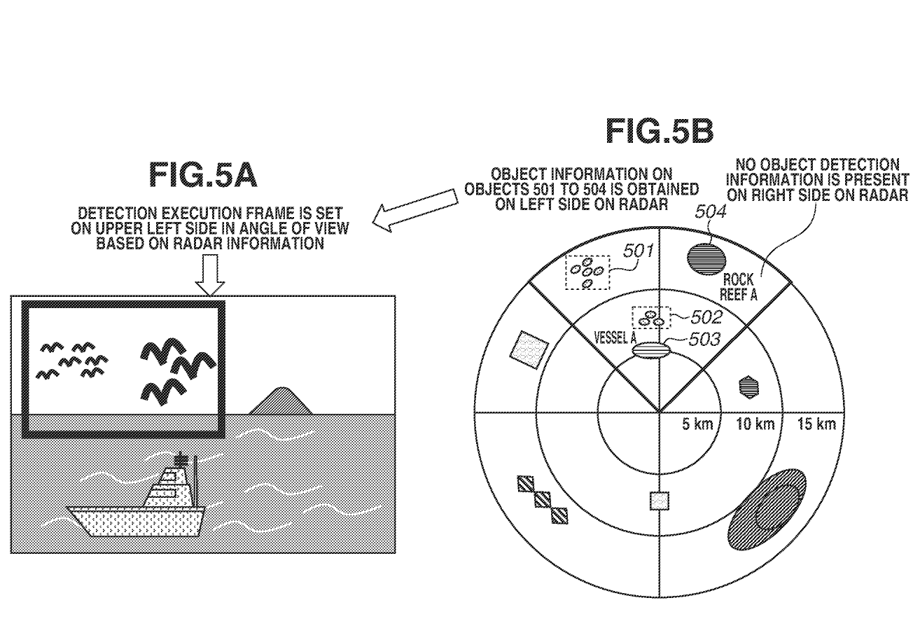

When the parameters are suitably set, detection processing is not performed on an unnecessary range, and erroneous detection can be suppressed. However, if the detection range is not set to a necessary range, the object to be essentially detected may be overlooked. Accordingly, in the present embodiment, a method of setting the detection range based on the object information acquired in step S202 is described. FIGS. 5A and 5B illustrate an example in which an object detection frame is set based on the object information. FIG. 5A illustrates the visible light image subjected to the gradation correction processing in step S203, and FIG. 5B illustrates the object information acquired in step S202. FIG. 5B illustrates that the object information is acquired on the left side in the angle of view of the visible light image, and detection information on the object is absent on the right side in the angle of view. Further, from the associated data based on the AIS information and the GPS information, it is known that each of a vessel 503 present on the lower left in the angle of view of the visible light image and a rock reef 504 present on the upper right in the angle of view is not a seabird to be detected in the present embodiment. For this reason, based on the above-described object information, a detection range is set to an upper left region in the angle of view that includes the detection information of the object and excludes a region where the object information other than for the detection target is present, in the visible light image. As a result, it is possible to perform the detection processing only on a region where there is a high possibility that seabirds 501 and 502 to be detected are present, without performing the detection processing on an unnecessary region.

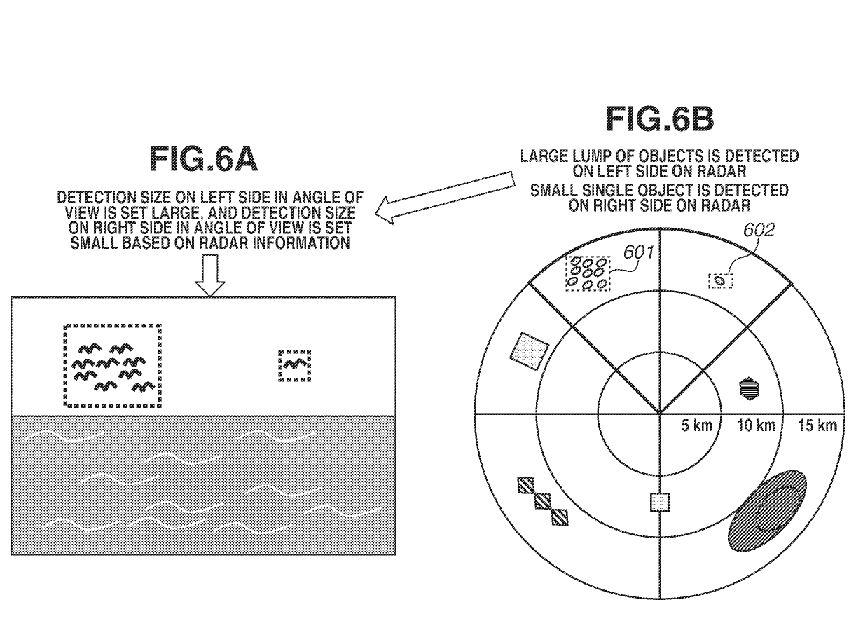

When the detection size is suitably set, the detection processing is not performed on an object that is not the detection target in the visible light image, and erroneous detection can be suppressed. However, if the detection size is not suitably set, erroneous detection and overlooking can occur. For this reason, in the present embodiment, a size setting method of setting a detection size based on the object information acquired in step S202 is described. FIGS. 6A and 6B illustrate an example in which the detection size is suitably set based on the object information. FIG. 6A illustrates the visible light image subjected to the gradation correction processing in step S203, and FIG. 6B illustrates the object information acquired in step S202. FIG. 6B illustrates that a large lump of objects 601 is detected on the left side in the angle of view of the visible light image, and a single object 602 is detected on the right side in the angle of view. Accordingly, based on the above-described object information, a large object detection size is set to a region on the left side in the angle of view where a plurality of objects may be present, and a small object detection size is set to a region on the right side in the angle of view, in order to not overlook detection of the seabird, in the visible light image.

Subsequently, when a high object threshold is set, it is possible to reduce erroneous detection of the object in the visible light image. However, overlooking of the object is increased. In contrast, when a low object threshold is set, erroneous detection of the object is increased, but overlooking of the object can be reduced. Thus, a so-called trade-off relationship is established. An object detection processing unit 105 according to the present embodiment outputs an evaluation value that indicates a likelihood of the object for each detected object. The evaluation value is output within a range from 0 to 100. When the above-described value and the object threshold are compared, and the evaluation value is smaller than the object threshold, the corresponding object is not detected as the detection target (seabird), whereas when the evaluation value is greater than or equal to the object threshold, the corresponding object is detected as the seabird. In the following, a method of setting the object threshold based on the image processing parameters of the gradation correction processing at the preceding stage is described. In a case where the visible light camera 11 and the radar 12 are used in a vessel, fog or mist may rise. In such a case, performing mist correction processing makes it possible to reduce the influence of fog and mist. The mist correction processing has a plurality of intensity settings so as to be matched with an environment. In this case, erroneous detection may be increased when the intensity is set to strong, or overlooking may be increased when the intensity is set to weak. A solution for the issue is described below.

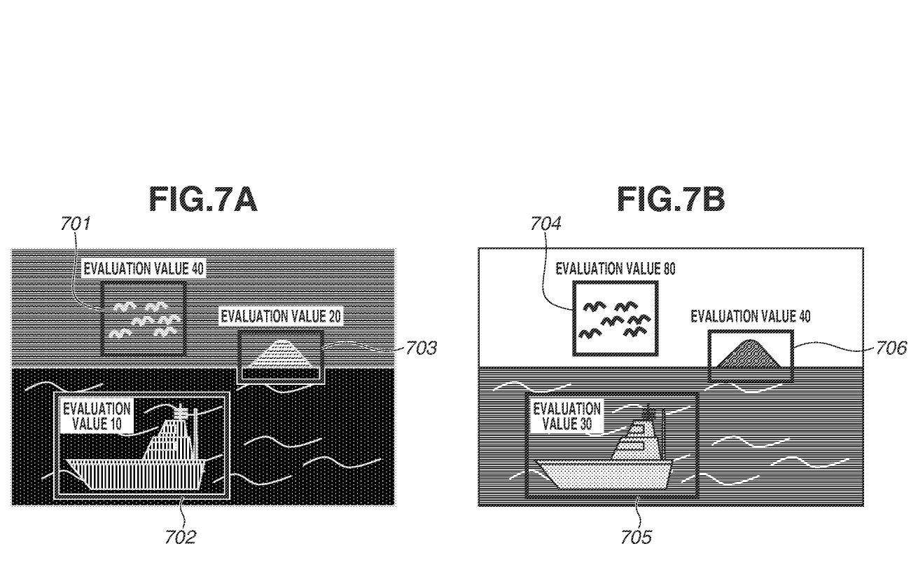

FIG. 7A illustrates a video image in a case where, under a situation where fog/mist rises, the "mist correction function" is set to "enabled," and the "mist correction intensity" is set to a "weak" parameter. FIG. 7B illustrates a video image in a case where, under the situation where fog/mist rises, the "mist correction function" is set to "enabled," and the "mist correction intensity" is set to a "strong" parameter. As illustrated in FIG. 7A, in the case where the "mist correction intensity" is set to "weak," evaluation values of objects including the seabird (predetermined object) in the visible light image are relatively low, and the object threshold is accordingly set to a low value. For example, when the object threshold is set to 30, it is possible to accurately detect a seabird 701 (evaluation value 40) (predetermined object) without erroneously detecting a vessel 702 (evaluation value 10) and a rock reef 703 (evaluation value 20) in step S205 described below. On the other hand, in the case where the "mist correction intensity" is set to "strong," contrast is given to the objects, the evaluation values become high, and the object threshold is accordingly set to a high value. For example, when the object threshold is set to 60, it is possible to accurately detect a seabird 704 (evaluation value 80) (predetermined object) without erroneously detecting a vessel 705 (evaluation value 30) and a rock reef 706 (evaluation value 40) in step S205 described below.

Finally, in step S205, detection processing is performed on the image subjected to the gradation correction processing in step S203 based on the detection parameters set in step S204.

As described above, in the present embodiment, the object detection method robust to an external environment (strong against contrast) is realized by setting the detection parameters based on the object information and the correction processing at the preceding stage. It is possible to prevent overlooking of the object detection or occurrence of erroneous detection in a case where the image processing parameters are changed and in a case of a dense fog environment where it is difficult to detect the object only from the visible light image.

In the present embodiment, as a sensing device unit for acquiring the object information other than visible light, the radar 12 is used as an example, but the configuration is not limited to radar. For example, a thermal camera, a sonar, a global navigation satellite system (GNSS), or an automatic identification system (AIS) may be used. Further, a sensing device that can acquire temperature information of objects including a vessel, a person, or an animal, weather information, position information, speed information, and the like may be provided.

In a case where a sensing device unit for acquiring information on weather is provided, the sensing device unit may acquire the weather information from external data. Further, current weather may be determined from the visible light image. The mist correction function and the mist correction intensity each may be switched based on the determined weather.

In the present embodiment, the method using the histogram is described as the method of calculating the fog/mist level, but another method may be adopted. For example, in a case where a contrast value of the visible light image is low, settings may be performed such that the fog/mist level becomes high, whereas in a case where the contrast value is high, settings may be performed such that the fog/mist level becomes low. Alternatively, processing such as a high-pass filter may be performed on the visible light image, and settings may be performed such that the fog/mist level becomes high as intensity of an edge component is strong. Further, a dark channel value of the visible light image may be calculated based on a dark channel prior method that is a well-known fog/mist removal method, and settings may be performed such that the fog/mist level becomes high in a region where the dark channel value is high.

In the present embodiment, the seabird is used as an example of the object to be detected, but the type of the object is not limited to a seabird, and the present embodiment can be realized even in a case of other types of objects. For example, the present embodiment can be realized by detecting objects such as an animal, a person, or a vehicle.

### <Second Embodiment>

In the first embodiment, the example in which the detection parameters of the object detection processing unit 105 are determined based on any of the object information acquired from the radar information acquisition unit 102 and the image processing parameters acquired from the gradation correction processing unit 103, and the object detection processing is performed is described. In a second embodiment, an example in which the detection parameters of the object detection processing unit 105 are set based on both the object information acquired from the radar information acquisition unit 102 and the image processing parameters acquired from the gradation correction processing unit 103, and the object detection processing is performed is described. Components in the second embodiment that are the same as the components in the first embodiment are denoted by the same reference numerals, and descriptions of the same components are omitted.

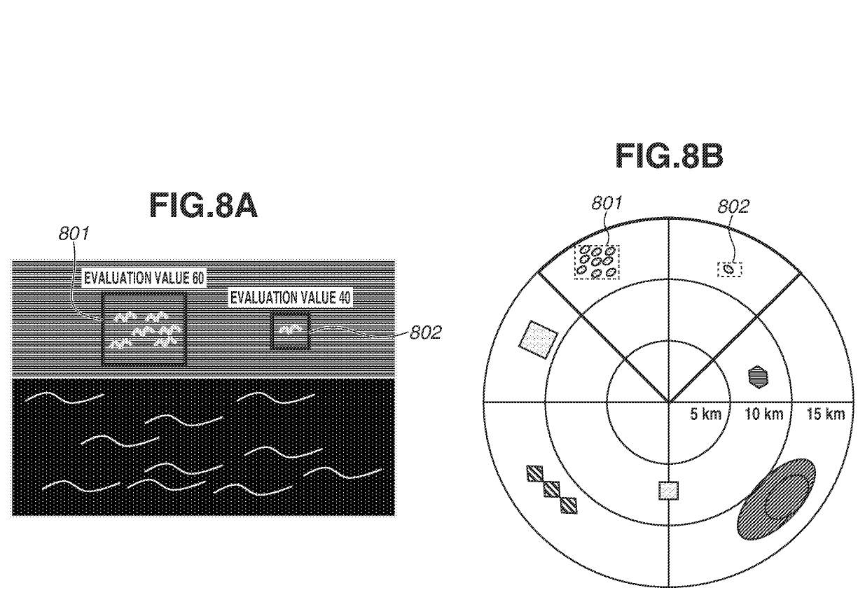

The processing from step S201 to step S203 illustrated in FIG. 2 is similar to the processing in the first embodiment, and accordingly, a description of this processing is omitted. Setting of the object threshold based on both the object information acquired from the radar 12 and the image processing parameters acquired from the gradation correction processing unit 103 is described with reference to FIGS. 8A and 8B. FIG. 8A illustrates a video image in a case where, under a situation where fog/mist rises, the "mist correction function" is set to "enabled" and the "mist correction intensity" is set to a "weak" parameter. FIG. 8B illustrates object information corresponding to FIG. 8A acquired from the radar information acquisition unit 102.

As illustrated in FIG. 8A, in the case where the "mist correction intensity" is set to "weak," evaluation values of objects including the seabird are low. Further, as can be seen from the object information illustrated in FIG. 8B, a large number of seabirds flock on the left side in the angle of view and are easily detected. On the other hand, the number of seabirds is small on the right side in the angle of view, and detection of the seabirds is difficult. Accordingly, since the "mist correction intensity" is set to "weak," the object threshold is set to a low value. In addition, because a large number of objects are present on the left side in the angle of view, the object threshold on the left side in the angle of view is relatively set high, and the object threshold on the right side in the angle of view is relatively set low. For example, the object threshold for a region (first region) on the left side in the angle of view is set to 50, and the object threshold for a region (second region) on the right side in the angle of view is set to 30. This makes it possible to accurately detect a lump of seabirds 801 and a single seabird 802 without performing erroneous detection.

As described above, in the present embodiment, the detection parameters are determine based on the information from the radar information acquisition unit 102 and the gradation correction processing unit 103, which makes it possible to further improve the object detection performance.

### <Other Embodiment>

The embodiments may be implemented as a program that can be stored in a computer-readable storage medium. The embodiments can be realized by supplying a program realizing one or more functions of the above-described embodiments to a system or an apparatus through a network or a storage medium and causing one or more processors in a computer of the system or the apparatus to read and execute the program.

The above-described disclosure of the embodiments includes the following aspects.

### (Aspect 1)

An object detection apparatus, including: an imaging unit configured to image a visible light image; a detection unit configured to detect an object exceeding a threshold as a detection target in the image captured by the imaging unit; a first change unit configured to change the threshold; a processing unit configured to perform correction processing related to contrast on the image captured by the imaging unit; a selection unit configured to select one setting from a plurality of settings including a first setting and a second setting, in which the processing unit performs correction processing to cause the contrast of the image captured by the imaging unit to be lower when the second setting is selected than when the first setting is selected; and a second change unit configured to change the threshold for detecting the detection target in the image captured by the imaging unit in a state where the first setting is selected to a value higher than the threshold for detecting the detection target in the image captured by the imaging unit in a state where the second setting is selected.

### (Aspect 2)

The object detection apparatus according to aspect 1, in which the correction processing is mist correction processing.

### (Aspect 3)

The object detection apparatus according to aspect 1 or 2, further including an acquisition unit configured to acquire information about an object by a radar, in which the change unit sets the threshold for detecting the detection target different between a first region in the image captured by the imaging unit and a second region different from the first region, based on the information acquired by the acquisition unit.

### (Aspect 4)

The object detection apparatus according to any one of aspects 1 to 3, further including: an acquisition unit configured to acquire information about an object by a radar; and a setting unit configured to set a detection range where the detection unit detects the detection target, based on the information acquired by the acquisition unit.

### (Aspect 5)

The object detection apparatus according to any one of aspects 1 to 4, further including: an acquisition unit configured to acquire information about an object by a radar; and a size setting unit configured to set a detection size of the detection target, based on the information acquired by the acquisition unit.

### (Aspect 6)

The object detection apparatus according to any one of aspects 1 to 5, in which the selection unit automatically selects one setting from the plurality of settings based on the visible light image.

### (Aspect 7)

The object detection apparatus according to aspect 6, in which the selection unit automatically selects one setting from the plurality of settings based on a histogram related to luminance of the visible light image.

### (Aspect 8)

The object detection apparatus according to any one of aspects 1 to 7, further including a determination unit configured to determine weather from the visible light image, in which the selection unit selects one setting from the plurality of settings based on the weather determined by the determination unit.

### (Aspect 9)

An object detection method including: capturing a visible light image; detecting an object exceeding a threshold as a detection target in the captured image; changing the threshold; performing correction processing related to contrast on the captured image; selecting one setting from a plurality of settings including a first setting and a second setting, in which the correction processing is performed to cause the contrast of the captured image to be lower when the second setting is selected than when the first setting is selected; and changing the threshold for detecting the detection target in the captured image in a state where the first setting is selected to a value higher than the threshold for detecting the detection target in the captured image in a state where the second setting is selected.

### (Aspect 10)

A program for causing at least one computer to function as each of the units of the object detection apparatus according to any one of aspects 1 to 8.

### (Aspect 11)

A non-transitory computer-readable storage medium storing a program for causing at least one computer to acquire a visible light image captured by an imaging unit and to function as each of the remaining units of the object detection apparatus according to any one of aspects 1 to 8. According to the present disclosure, it is possible to accurately detect the detection target by the camera system including a function of mist correction.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-185764, filed October 22, 2024, the entirety of which is incorporated herein by reference.

What is claimed is:

1. An object detection apparatus comprising:
an imaging unit configured to capture a visible light image;
at least one memory storing a program; and
at least one processor that, upon execution of the stored program, is configured to function as:
a detection unit configured to detect an object exceeding a threshold as a detection target in the image captured by the imaging unit;
a first change unit configured to change the threshold;
a processing unit configured to perform correction processing related to contrast on the image captured by the imaging unit;
a selection unit configured to select one setting from a plurality of settings including a first setting and a second setting, wherein the processing unit performs correction processing to cause the contrast of the image captured by the imaging unit to be lower when the second setting is selected than when the first setting is selected; and
a second change unit configured to change the threshold for detecting the detection target in the image captured by the imaging unit in a state where the first setting is selected to a value higher than the threshold for detecting the detection target in the image captured by the imaging unit in a state where the second setting is selected.

2. The object detection apparatus according to claim 1, wherein the correction processing is mist correction processing.

3. The object detection apparatus according to claim 1,
wherein the at least one processor, upon execution of the stored program, is configured to further function as an acquisition unit configured to acquire information about an object by a radar, and
wherein the change unit sets the threshold for detecting the detection target different between a first region in the image captured by the imaging unit and a second region different from the first region, based on the information acquired by the acquisition unit.

4. The object detection apparatus according to claim 1, wherein the at least one processor, upon execution of the stored program, is configured to further function as:
an acquisition unit configured to acquire information about an object by a radar; and
a setting unit configured to set a detection range where the detection unit detects the detection target, based on the information acquired by the acquisition unit.

5. The object detection apparatus according to claim 1, wherein the at least one processor, upon execution of the stored program, is configured to further function as:
an acquisition unit configured to acquire information about an object by a radar; and
a size setting unit configured to set a detection size of the detection target based on the information acquired by the acquisition unit.

6. The object detection apparatus according to claim 1, wherein the selection unit automatically selects one setting from the plurality of settings based on the visible light image.

7. The object detection apparatus according to claim 6, wherein the selection unit automatically selects one setting from the plurality of settings based on a histogram related to luminance of the visible light image.

8. The object detection apparatus according to claim 1,
wherein the at least one processor, upon execution of the stored program, is configured to further function as a determination unit configured to determine weather from the visible light image, and
wherein the selection unit selects one setting from the plurality of settings based on the weather determined by the determination unit.

9. An object detection method comprising:
capturing a visible light image;
detecting an object exceeding a threshold as a detection target in the captured image;
changing the threshold;
performing correction processing related to contrast on the captured image;
selecting one setting from a plurality of settings including a first setting and a second setting, wherein the correction processing is performed to cause the contrast of the captured image to be lower when the second setting is selected than when the first setting is selected; and
changing the threshold for detecting the detection target in the captured image in a state where the first setting is selected to a value higher than the threshold for detecting the detection target in the captured image in a state where the second setting is selected.

10. A non-transitory computer-readable storage medium storing a program for causing at least one computer to acquire a visible light image captured by an imaging unit and to function as each of the remaining units of the object detection apparatus according to claim 1.
